(19) United States
(12) Patent Application Publication
(10) Pub. No.: US 2008/0021737 A1
(43) Pub. Date: Jan. 24, 2008

(54) Method and system for providing a medical service

(75) Inventors: Amitabh K. Dutt, Tiburon, CA (US); Bradley S. Dean, Needham, MA (US); Nicholas S. Donovan, Orinda, CA (US); Manish Kothari, San Rafael, CA (US); Patricia Kubicki, San Francisco, CA (US); Colleen T. Lindsey, San Francisco, CA (US); Charles G. Peterfy, Kentfield, CA (US); Martine M. Sieffert, San Francisco, CA (US); Radhika Sivaramakrishna, Pleasanton, CA (US); Joyce Suhy, Castro Valley, CA (US); Gabriele von Ingersleben, Alameda, CA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Synarc, Inc., San Francisco, CA (US)

(21) Appl. No.: 11/880,243

(22) Filed: Jul. 20, 2007

Related U.S. Application Data
(60) Provisional application No. 60/832,721, filed on Jul. 21, 2006.

(51) Int. Cl. G06Q 50/00

(52) U.S. Cl. 705/2

(57) ABSTRACT

A method for providing a medical service in a therapeutic area requested by a client. In one embodiment, the method includes the step of defining a plurality of offerings associated with the medical service in the therapeutic area. At least one service category is associated with each of the offerings. At least one activity is associated with each of the service categories. At least one tool is associated with each of the activities. The method further includes the step of associating the offerings, the activities, the service categories and the tools with a respective plane of a hypercube. In response to the medical service, at least one location in the hypercube, which represents the offering, service category, activity and tool required to provide the medical service, is identified.

### RELATED APPLICATION

This application claims priority to and benefit of U.S. provisional patent application No. 60/832,721 the entire content of which is incorporated by reference herein.

### BACKGROUND FOR THE INVENTION

The field of the invention generally is the providing of a service and, more specifically, to providing a medical service in response to a request by a client.

Medical professionals and researchers perform medical services everyday in various therapeutic areas. Each of these services requires different offerings (products). Each of the offerings may include one or more services. Every service is an aggregation of a number of activities, each of which may be carried out using different tools. Although many available offerings, services, activities and tools are known to be useful for one or more medical services, there is generally still no efficient and systematic way of categorizing them.

Now when a clinical trial for a new medicine is proposed, the researchers planning the clinical trial need to do an exhaustive search to determine first which offerings are suited for the specific trial. Next, they have to select the services associated with the offerings, then the activities making up the services, and finally the tools to perform the activities. Not only is this process labor intensive, it is also ad-hoc—the same exhaustive search and decision making process has to be repeated when a second similar trial is performed because of the lack of a well-organized data structure to store and categorize the available information.

What is needed is a way to track all related offerings, services, activities and tools for the purpose of responding to a request for medical service so that a particular grouping of offerings, services, activities and tools is instantaneously obtainable given any medical service.

### SUMMARY OF THE INVENTION

The invention relates generally to a method and system for providing a medical service in a therapeutic area by identifying the combination of offerings, service categories, activities and tools required to provide the service.

In one aspect, the invention relates to a method for providing a medical service in a therapeutic area requested by a client. In one embodiment, the method includes the step of defining a plurality of offerings associated with the medical service in the therapeutic area. At least one service category is associated with each of the offerings. At least one activity is associated with each of the service categories. At least one tool is associated with each of the activities. The method further includes the step of associating each of the offerings, the service categories, the activities, and the tools with a respective plane of a hypercube. In response to a request for the medical service, at least one location in the hypercube, which represents the offering, service category, activity and tool required to provide the medical service, is identified.

In another embodiment, the medical service is a clinical service. In another embodiment, the clinical service is a clinical trial service. In some embodiments, the clinical trial service is selected from the group including scientific consulting, site support, study management, image and data management, image reading, site selection, and regulatory submission. In the embodiments where the clinical trial service is image reading, the activity is selected from the group including equipment performance assessment, patient eligibility assessment, image quality control, image analysis, multi-reader adjudication, patient safety assessment, third party image quality control, third party image analysis, and intra- and inter-reader validation. In yet another embodiment, the method further includes the step of defining at least one task associated with each of the activities. In this embodiment, at least one of the tools is associated with each of the tasks.

In still yet another embodiment, the clinical trial service is image reading. The activity, in this embodiment, is image analysis. The task is selected from the group including specification completion and confirmation, analysis baseline confirmation, blinding requirement confirmation, outlier checking determination, reader training and qualification, analysis, and report generation. In yet another embodiment, the tool is selected from the group including a site database, an image viewing system, and guidelines for the image readers.

In another aspect, a method for providing medical services in a therapeutic area requested by a client using a linked list of records is provided. In one embodiment, the method includes the step of defining a record for each of a plurality of offerings associated with the medical service in the therapeutic area. A record for at least one service category is associated with a record of each of the offerings. A record for at least one activity is associated with a record of each of the service categories. A record for at least one tool is associated with a record of each of the activities. The method further includes the step of associating, in at least one linked list, records of each of the plurality of the offerings, the activities, the service categories and the tools. In response to the medical services in the therapeutic area requested by the client, at least one linked list, which represents the offering, service, activity and tool required to provide the medical service, is identified.

In yet another aspect, a method for providing medical services in a therapeutic area requested by a client using objects, classes and instantiations is provided. In one embodiment, the method includes the step of defining an offering class associated with the medical service in the therapeutic area. The offering class includes a plurality of offering objects. A service category class includes at least one service category object. The service category objects are associated with at least one of the offering objects in the offering class. An activity class includes at least one activity object. The activity objects are associated with at least one of the service category objects in the service category class. A tool class includes at least one tool object. The tool objects are associated with at least one of the activity objects in the activity class. The method further includes the steps of linking, in at least one association, offering objects in the offering class, service category objects in the service category class, activity objects in the activity class, and tool objects in tool class. In response to the medical services in the therapeutic area requested by the client, at least one association which defines the offering objects, the service category objects, the activity objects, and the tool objects required to provide the medical service to the client is provided.

In yet another aspect, a system for providing a medical service in a therapeutic area to a client is provided. The system defines a plurality of offerings associated with the medical service in the therapeutic area. The system further defines at least one service category associated with each of the offerings, at least one activity associated with each of the service categories, and at least one tool associated with each of the activities. The system joins, in a database, each of the plurality of offerings, the activities, the service categories, and the tools. In response to the medical service requested by the client, the system locates, at least one entry in the database which defines the offering, services, activities and tools required to provide the medical service to the client.

In yet another aspect, a system for providing medical service to a client is provided. The system includes a database. The database includes a plurality of offerings associated with the medical service, at least one service category associated with each of the offerings, at least one activity associated with each of the service categories, and at least one tool associated with each of the activities. The database further includes an input device to input a request for the medical service, a processor for locating at least one entry in the database which identifies the offering, service, activity and tool required to provide the medical service to the client, and an output device displaying the entry.

In yet another aspect, a method for providing a medical service requested by a client is provided. In one embodiment, the method includes the step of defining a plurality of offerings associated with the medical service. At least one service category is associated with each of the offerings. At least one activity is associated with each of the service categories. At least one tool is associated with each of the activities. The method further includes the step of associating each of the plurality of offerings, the activities, the service categories and the tools. In response to the medical service requested by the client, at least one offering, service category, activity and tool required to provide the medical service to the client is identified, and the medical service is provided to the client.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a diagram illustrating a hypercube representing a method of locating information required to provide medical services, according to an embodiment of the invention;

FIG. 2 is a block diagram illustrating a linked-list structure representing information required in a method for providing medical services, according to an embodiment of the invention;

FIG. 3 is a block diagram illustrating an object-oriented structure representing information required in a method for providing medical services, according to an embodiment of the invention;

FIG. 4 is a block diagram illustrating the major components of a system for providing medical services, according to an embodiment of the invention;

FIG. 5A is a flow chart illustrating the steps of setting up an image analysis activity, according to an embodiment of the invention;

FIG. 5B is a flow chart illustrating the steps of performing an image analysis activity, according to an embodiment of the invention; and

FIG. 5C is a flow chart illustrating the steps of edit checking the result of an image analysis activity, according to an embodiment of the invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

In brief overview, the invention disclosed herein relates to methods and systems for providing a medical service in a therapeutic area by identifying one or more paths through a hierarchical data structure. The data structure stores detailed information such as offerings, service categories, activities and tools available for all medical services. Each suitable path through the data structure represents a unique combination of such offering, service, activity and tool required for the requested service. Because the hierarchical structure provides a well organized and easily accessible way of managing large amount of information, query results are readily available for client's review. As such, the system further assists the client in selecting the combination of services that best satisfies the client's needs.

In one embodiment, the hierarchical structure is defined by each of its four levels, namely Offering, Service Category, Activity and Tool. A plurality of offerings are available for each medical service in a therapeutic area. There is at least one service category available for each offering. The same service category may be suitable for a number of different offerings. Each service category is a bundle of one or more related activities. Each activity is associated with at least one tool necessary to carry out that activity. Similarly, a tool may be used to carry out a variety of activities. In another embodiment, an additional level, Task, is built into the hierarchy between Activity and Tool so that each activity is divided into at least one task and the same task may also be a part of a different activity. Regardless of the number of levels in a hierarchy, once the hierarchical data structure is in place, one or more combinations of information at each level of the structure can be identified for a given medical service in a therapeutic area.

For example, if lymphoma service is the offering associated with a clinical trial, one of the service categories available for the offering, according to one embodiment, is image reading. An image reading service can include a number of activities, which in one embodiment is image analysis. In one embodiment a tool necessary to carry out image analysis is an image viewing system. Therefore, for example one service requested by a client is the combination of the lymphoma offering, the image reading service, the image analysis activity, and using the image viewing system as the tool. The following are a number of different representations of the data structures may take to locate the resulting solutions to a client request.

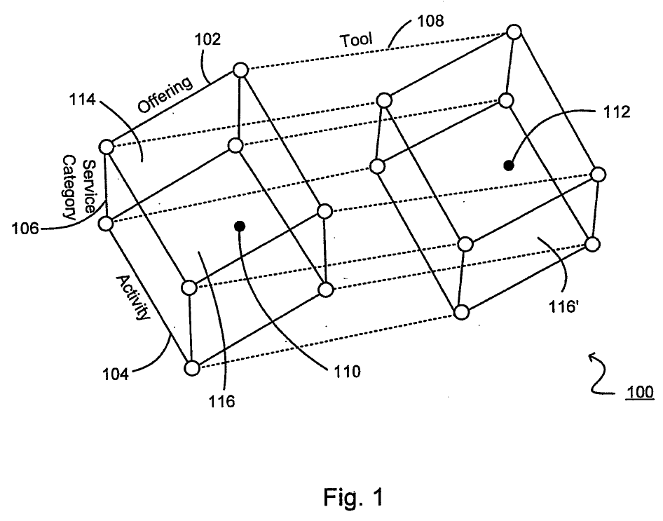

Referring to FIG. 1, the hierarchical structure is represented by a four-dimensional hypercube 100. Each of the four orthogonal planes of the hypercube 100 corresponds to a level in the hierarchy. The orthogonal coordinate (w, x, y, z) of a point 110 in the hypercube 100 represents a unique path through the four levels (offering, service category, activity, and tool) of the hierarchy. As illustrated in FIG. 1, the first three dimensions of the hypercube 100 is a regular cube 116. The cube 116 is defined by an offering (w) axis 102, a service category (x) axis 106, and an activity (y) axis 104, each orthogonal to the other two. A point 110 in the cube 116 identifies the path through the first three levels of the hierarchy by giving its w, x, and y coordinates in order. To extend the path through the fourth level and designate a tool suitable for the identified combination of offering, service category and activity, a fourth dimension is illustrated by the respective position of the 3-D cube 116, 116′ along the tools axis 108 in respect to a forth orthogonal plane. The points 110, 112 in the hypercube 100, although having the same Offering (w), Service Category (x) and Activity (y) coordinates as shown by their identical positions in the first three dimensions of the hypercube 100, are only distinguished by their respective fourth (z) coordinates. As such, the points 110, 112 represent two different tools available for the same combination of offering, service category and activity.

Accordingly, each point in the hypercube 100 defines a unique association of an offering, a service category, an activity and a tool. Once a request for a medical service is accepted and the offerings for the medical service are identified, points in the hypercube 100 with matching Offering coordinates are located. The coordinate of each of these points corresponds to a set of offering, service category, activity and tool required to provide the medical service.

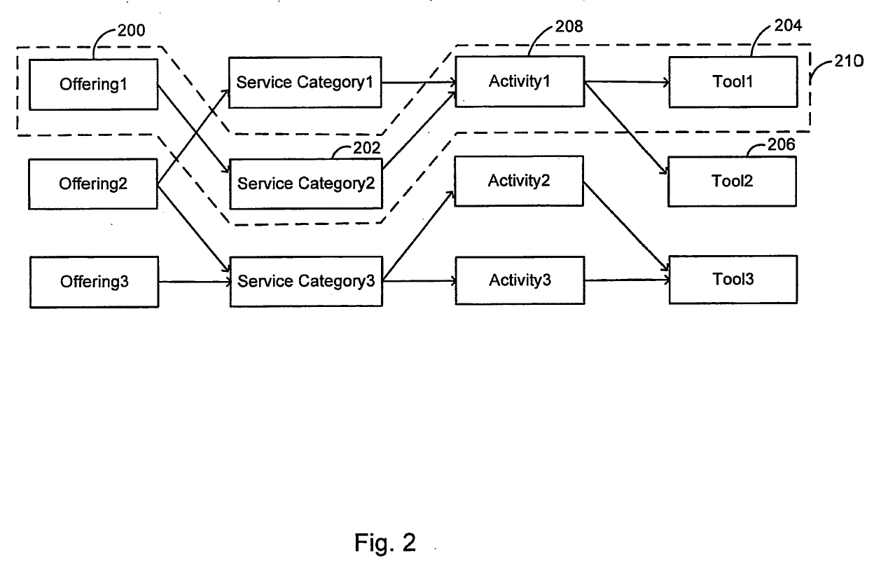

The same hierarchical structure can be constructed as a linked list. Referring to FIG. 2, a record is defined for each available offering, service, activity and tool in the data structure. In one embodiment, each record includes an address and at least one pointer, which points to the address of another record to create a link between the two records. In this structure, each record of offering is linked with at least one record of service category, each service category with at least one activity, and each activity with at least one tool. When an offering is selected for a requested medical service, each linked list starting with the record of that offering and containing one service category record, one activity record and one tool record represents a set of information required for the medical service. For example, as illustrated in FIG. 2, the records of Offering1 200, Service Category2 202, Activity1 208 and Tool1 204 are linked to form a linked list 210. For every medical service that Offering1 is associated with, the linked list 210 defines the one combination of required offering, service category, activity and tool.

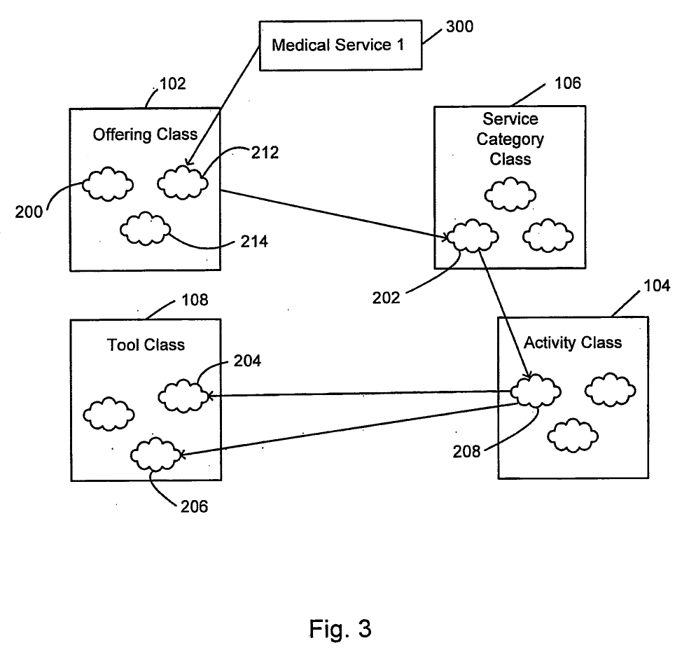

A third way of embodying the same hierarchical structure is to use an object-oriented model. Referring to FIG. 3, each of the four levels in the hierarchical structure is defined as a class containing a group of objects of the same type. In other words, each object is an instance of the class to which it belongs. For example, the Offering Class 102 contains a plurality of offering objects 200, 212, 214 representing the different offerings available for medical services. Each offering objects 200, 212, 214 is associated with at least one service category object in the Service Category Class 106, each service category object with at least one activity object in the Activity Class 104, and each activity object with at least one tool object in the Tool Class 108. A set of associated objects, one from each class, defines what is required for a medical service so long as the offering object in the set is associated with the medical service.

In some embodiments, the medical service requested is a clinical service, more specifically, a clinical trial service. A typical clinical trial service may be one of the following: scientific consulting, site support, study management, image and data management, image reading, site selection, and regulatory submission. In the embodiments where the clinical trial service is image reading, the related activity may be equipment performance assessment, patient assessment, image quality control, image analysis, multi-reader adjudication, patient safety assessment, third party image quality control, third party image analysis, or intra and inter-reader validation. The tools available for the activity may be either a site database or an image viewing system or a guideline for image readers.

In yet other embodiments, the hierarchical structure is not limited to the four levels discussed above. Additional levels may be added anywhere in the hierarchy and associated with the levels immediately above and below. For example, a task may be inserted between an activity and a tool in the data structure so that the activity is associated with at least one task and the task is associated with at least one tool. The original direct association of the activity and the tool is deleted. In the hypercube illustration in FIG. 1, task will be a fifth dimension of the hypercube and the coordinate of a point in the five dimensional hypercube identifies one set of required information for a given medical service. Similarly, in the linked list of FIG. 2, an additional record of a task will be linked with at least one activity record and one tool record. The object-oriented diagram of FIG. 3 will include a new class of task objects.

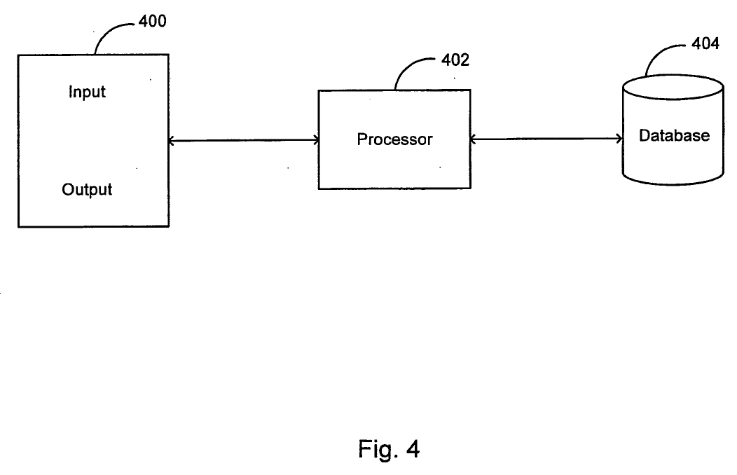

FIG. 4 is a block diagram illustrating the major components of a system for executing the methods of this invention relating to the provisioning of medical services. In this embodiment, the system includes an input/output device 400, a processor 402, and a database 404. The database contains a plurality of offerings, at least one service category, at least one activity, and at least one tool. In one embodiment, the database is a relational database, and the offerings, service categories, activities, and tools are stored in respective tables in the database. The tables are also constructed to specify many-to-many relationships between the offerings and the service categories, the service categories and the activities, and the activities and the tools, given that more than one of each are stored in the tables.

Before the database 404 can be queried, the tables in the database 404 need to be populated with data sets capturing all available offerings, service categories, tasks, tools and other information. In operation, a request for medical service is entered by the input/output device 400 to the processor 402. The processor 402 generates a query using the medical service as a parameter to select the list of entries each containing an offering, a service category, an activities and a tool that satisfies the requirement for the medical service. The database 404 processes the query through a series of internal joining and selecting operations and returns the desired list. The list is passed to the input/output device 400 and displayed in a predefined format. In another embodiment, the system includes separate input and output devices, each connected to the processor 402. Depending on the data structure (for example, the number of levels in the hierarchy), additional tables may be created in the database 404 with proper modifications to the relationships between the tables.

A request for a medical service may be received by phone or online or in one of any number of different ways. Upon receiving the request, a user inputs it into the system described in the preceding paragraph and receives an output of a list of the matching combinations of offering, service category, activity and tool to provide the medical service. Clinicians can then select from the list the optimal combination for the actual implementation of the service. During implementation, the system can also assist the clinicians in mapping out the steps for carrying out each of the selected services/activities to optimize efficiency and reduce errors in the results.

For example, if image reading/image analysis is the desired combination of service category and activity for a particular clinical trial, the system will automatically generate a procedural guideline for completing the activity. Furthermore, the system provides recommendations of the personnel and tools most suitable for performing each step of the activity. In one embodiment, the activity of image analysis is a three-part process: preparing the images for analysis, analyzing the images, and edit checking of the results.

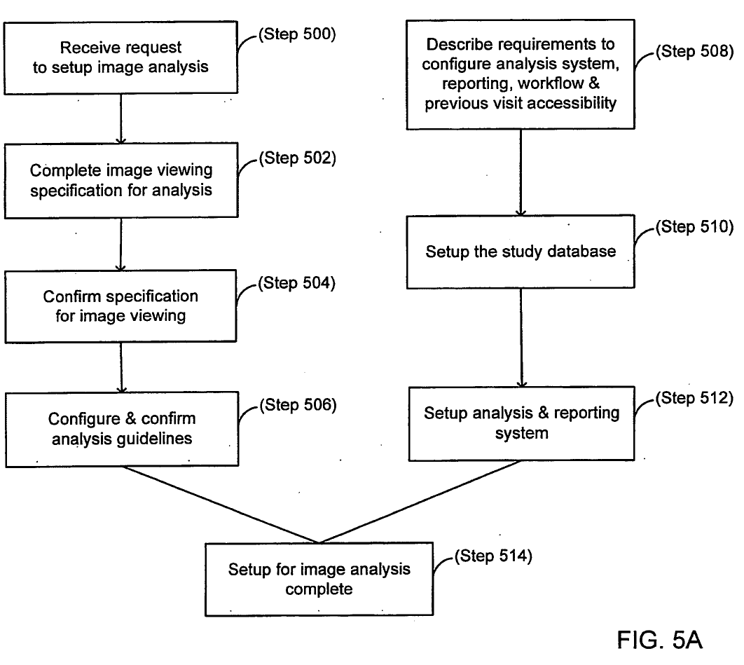

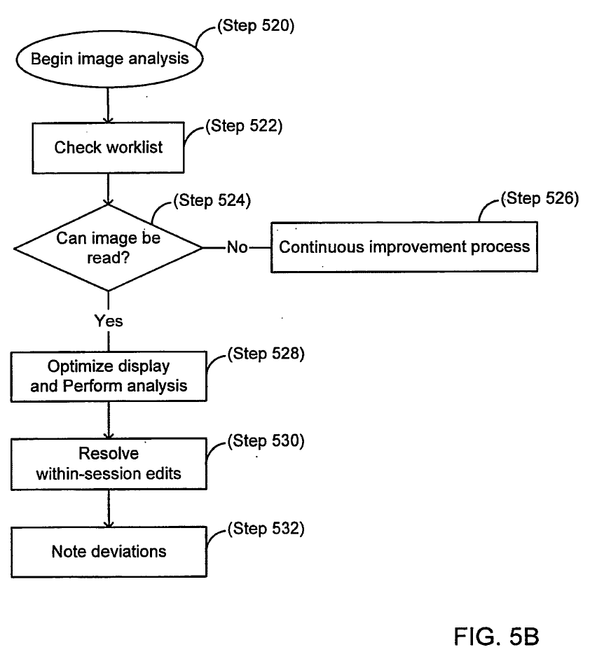

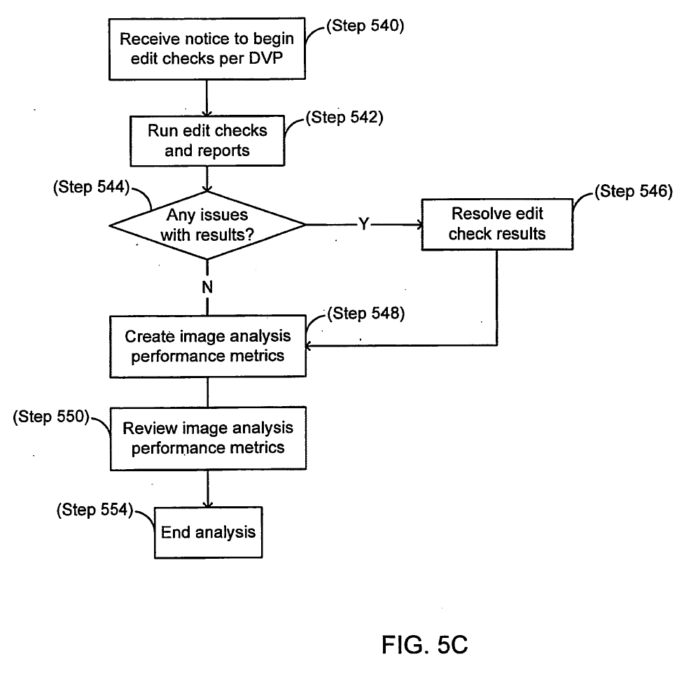

FIG. 5A is a flow chart describing the steps involved in preparing images for analysis, according to this embodiment. After receiving a request to set up an image analysis (Step 500), the Science/Medical Director first completes the image viewing specifications for analysis based on study-specific documents such as protocols, user requirements, imaging charter, and statement of work (Step 502). The image viewing specification is then passed on to the image reader for confirmation (Step 504). The image reader is generally a person specialized in the interpreting of medical images such as x-ray and MRI images. Using a template analysis guideline, the image reader converts the specification into a study-specific analysis guideline (Step 506), which takes him through the analysis process step-by-step.

Another aspect of preparing for an image analysis involves setting up a system capable of storing information obtained from image reading and generating reports based on the information. To put in place a customized system for a particular trial, engineers first have to describe the requirements to configure the system, including the different features of the system such as reporting, workflow and previous visit accessibility (Step 508). A template of user requirements for an image analysis system is available as reference. Based on the requirements, the engineers then create a Study Database including parameters to serve as a general depository of information to be acquired through the image analysis process (Step 510). Similarly, an analysis and reporting system is programmed to be in communication with the Study Database and capable of generating and customizing reports based on user defined criteria. With both the guideline and the system in place, qualified analysis image reader may begin the image analysis process.

FIG. 5B is a flow chart describing the actual image analysis process, according to the embodiment. Upon receiving the notice to begin analysis (Step 520), the image reader first checks the worklist comprising the images to be analyzed. Based on the worklist, the image reader retrieves the images from the image repository with correlated information from the Study Database (Step 522). The images are then inspected to see whether they are readable (Step 524). If the images are defective or illegible, then a continuous improvement process is carried out to assure the subsequent obtaining of quality images (Step 526). Otherwise, an image viewing/analysis application is loaded to optimize the display of the images and perform an analysis of the images (Step 528). The application automatically makes within-session edits to correct out-of range and improperly formatted values (Step 530). Any deviations observed are noted in the Study Database (Step 532). In addition, as the application performs the analysis, the status of each image and the analysis results including markings on the images are constantly updated in the Study Database. After the application finishes its analysis, the images are archived following an image optimization process. In this embodiment, steps 524, 528, 530, and 532 are carried out during a single user session while the image reader runs the analysis application.

To complete the image analysis, edit checks have to be performed by the Clinical Data Management (CDM) to verify the results. Referring to FIG. 5C, after the application completes its analysis, a notice is sent to the Clinical Data Management to start edit checks of the results (Step 540). The edit checks are based on a predefined Data Validation Plan (DVP) and existing Query and Report Templates (Step 542). The DVPs specify the edit checks required to validate the results and take the CDM step-by-step through the checking process. If the edit checks reveal any issues with the image results (Step 544), the edit checks are sent back to the image reader to have the issues resolved (Step 546). Otherwise, the CDM creates image analysis performance metrics (Step 548). The performance metrics are then sent to both the project manager and the imaging/Dual Energy X-ray Absorption (DXA) manager for review (Step 550). The image analysis is deemed complete if both managers concur with the results shown by the metrics (Step 554). In this embodiment, the performance of the site running the edit checks is recorded in a Site Database.

FIGS. 5A, 5B, and 5C illustrate in detail the numerous steps involved in the process of performing an image analysis, one of the activities associated with image reading. In this embodiment, the various templates, the Study Database, and the image viewing/analysis application are all tools necessary for image analysis. Similarly, other activities may be divided into individual steps, each designated to be performed with one or more available tools base on the hierarchical data structure.

Although the embodiments disclosed above are discussed in the scope of providing solutions in response to a request for a medical service, one of ordinary skill in the art can easily adopt the same methods and systems for the providing of other type of services. Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method for providing a medical service in a therapeutic area requested by a client comprising the steps of:
defining a plurality of offerings associated with said medical service in said therapeutic area;
defining at least one service category associated with each of said offerings;
defining at least one activity associated with each of said at least one service category;
defining at least one tool associated with each of said at least one activity;
associating each of said plurality of offerings, said at least one activity, said at least one service category and said at least one tool with a respective plane of a hypercube; and
defining, in response to said medical service in said therapeutic area requested by said client, at least one location in said hypercube which defines the offering, service category, activity and tool required to provide said medical service to said client.

2. The method of claim 1 wherein said medical service is a clinical service.

3. The method of claim 2 wherein said clinical service is a clinical trial service.

4. The method of claim 3 wherein said clinical trial service is selected from the group consisting of: scientific consulting, site support, study management, image and data management, image reading, site selection, and regulatory submission.

5. The method of claim 4 wherein said clinical trial service is image reading and said activity is selected from the group consisting of: equipment performance assessment, patient eligibility assessment, image quality control, image analysis, multi-reader adjudication, patient safety assessment, third party image quality control, third party image analysis, and intra- and inter-reader validation.

6. The method of claim 1 further comprising the step of defining at least one task associated with each of said at least one activity and wherein the step of defining said at least one tool defines said at least one tool associated with each of said at least one task.

7. The method of claim 6 wherein said medical service is a clinical trial service,
wherein said clinical trial service is image reading,
wherein said at least one activity is image analysis,
wherein said at least one task is selected from the group consisting of: image viewing specifications completion and confirmation, analysis baseline confirmation, blinding requirement confirmation, method of outlier checking determination, reader training and qualification, analysis, and report generation.

8. The method of claim 7 wherein said at least one tool is selected from the group consisting of: a site database and an image viewing system.

9. A method for providing medical services in a therapeutic area requested by a client comprising the steps of:
defining a record for each of a plurality of offerings associated with said medical service in said therapeutic area;
defining a record for at least one service category associated with each of said offerings;
defining a record for at least one activity associated with each of said at least one service category;
defining a record for at least one tool associated with each of said at least one activity;
associating said record of each of said plurality of offerings, said record of said at least one activity, said record of said at least one service category and said record of said at least one tool in at least one linked list; and
defining, in response to said medical services in said therapeutic area requested by said client, at least one said linked list which defines the offering, services, activities and tools required to provide said medical service to said client.

10. The method of claim 9 wherein said medical service is a clinical service.

11. The method of claim 10 wherein said clinical service is a clinical trial service.

12. The method of claim 11 wherein said clinical trial service is selected from the group consisting of: scientific consulting, site support, study management, image and data management, image reading, site selection, and regulatory submission.

13. The method of claim 12 wherein said clinical trial service is image reading and said activity is selected from the group consisting of: equipment performance assessment, patient eligibility assessment, image quality control, image analysis, multi-reader adjudication, patient safety assessment, third party image quality control, third party image analysis, and intra- and inter-reader validation.

14. The method of claim 9 further comprising the step of defining a record for at least one task associated with each of said at least one activity and wherein the step of defining said record of said at least one tool defines said at least one tool associated with each of said at least one task.

15. The method of claim 14 wherein said medical service is a clinical trial service,
wherein the clinical trial service is image reading,
wherein the at least one activity is image analysis,
wherein the at least one task is selected from the group consisting of: image viewing specifications completion and confirmation, analysis baseline confirmation, blinding requirement confirmation, method of outlier checking determination, reader training and qualification, analysis, and report generation.

16. The method of claim 15 wherein said at least one tool is selected from the group consisting of: a site database and an image viewing system.

17. A method for providing medical services in a therapeutic area requested by a client comprising the steps of:
defining an offering class associated with said medical service in said therapeutic area, said offering class comprising a plurality of offering objects;
defining a service category class comprising at least one service category object associated with at least one of said plurality of offering objects in said offering class;
defining an activity class comprising at least one activity object associated with at least one of said at least one service category object in said service category class;
defining a tool class comprising at least one tool object associated with at least one of said at least one activity object in said activity class;
linking each of said plurality of offering objects in said offering class, said at least one service category object in said service category class, said at least one activity object in said activity class, and said at least one tool object in said tool class in at least one association; and
defining, in response to said medical services in said therapeutic area requested by said client, at least one said association which defines said offering object in said offering class, said service category object in said service category class, said activity object in said activity class, and said tool object in said tool class required to provide said medical service to said client.

18. The method of claim 17 wherein said medical service is a clinical service.

19. The method of claim 18 wherein said clinical service is a clinical trial service.

20. The method of claim 19 wherein said clinical trial service is selected from said service category class consisting of: scientific consulting, site support, study management, image and data management, image reading, site selection, and regulatory submission.

21. The method of claim 20 wherein said clinical trial service is image reading and said activity object is selected from said activity class consisting of: equipment performance assessment, patient eligibility assessment, image quality control, image analysis, multi-reader adjudication, patient safety assessment, third party image quality control, third party image analysis, and intra- and inter-reader validation.

22. The method of claim 17 further comprising the step of defining a task class comprising at least one task object and wherein the step of defining said tool class defines said at least tool object associated with each of said at least one task object;

23. The method of claim 22 wherein said medical service is a clinical trial service,
wherein said clinical trial service is image reading,
wherein said at least one activity object is image analysis,
wherein said at least one task object is selected from said task class consisting of: image viewing specifications completion and confirmation, analysis baseline confirmation, blinding requirement confirmation, method of outlier checking determination, reader training and qualification, analysis, and report generation.

24. The method of claim 23 wherein said at least one tool object is selected from said tool class consisting of: a site database and an image viewing system.

25. A system for providing a medical service in a therapeutic area to a client comprising:
means for defining a plurality of offerings associated with said medical service in said therapeutic area;
means for defining at least one service category associated with each of said offerings;
means for defining at least one activity associated with each of said at least one service category;
means for defining at least one tool associated with each of said at least one activity;
means for joining each of said plurality of offerings, said at least one activity, said at least one service category and said at least one tool in a database; and
means for locating, in response to said medical service requested by said client, at least one entry in said database which defines the offering, services, activities and tools required to provide said medical service to said client.

26. The system of claim 25 wherein said medical service is a clinical service.

27. The system of claim 26 wherein said clinical service is a clinical trial service.

28. The system of claim 27 wherein said clinical trial service is selected from the group consisting of: scientific consulting, site support, study management, image and data management, image reading, site selection, and regulatory submission.

29. The method of claim 28 wherein said clinical trial service is image reading and said activity is selected from the group consisting of: equipment performance assessment, patient eligibility assessment, image quality control, image analysis, multi-reader adjudication, patient safety assessment, third party image quality control, third party image analysis, and intra- and inter-reader validation.

30. The system of claim 25 further comprising means for defining at least one task associated with each of said at least one activity and means for defining said at least one tool associated with each of said at least one task.

31. The system of claim 30 wherein said medical service is a clinical trial service,
wherein said clinical trial service is image reading,
wherein said at least one activity is image analysis,
wherein said at least one task is selected from the group consisting of: image viewing specifications completion and confirmation, analysis baseline confirmation, blinding requirement confirmation, method of outlier checking determination, reader training and qualification, analysis, and report generation.

32. The system of claim 31 wherein said at least one tool is selected from the group consisting of: a site database and an image viewing system.

33. A system for providing medical service to a client comprising:
a database comprising a plurality of offerings associated with said medical service, at least one service category associated with each of said offerings, at least one activity associated with each of said at least one service category, and at least one tool associated with each of said at least one activities;
an input device to input a request for said medical service;
a processor for locating, in response to said medical service input request, at least one entry in said database which defines the offering, service, activity and tool required to provide said medical service to said client; and
an output device displaying the offering, service, activity and tool required to provide said medical service to said client.

34. The system of claim 33 wherein said medical service is a clinical service.

35. The system of claim 34 wherein said clinical service is a clinical trial service.

36. The system of claim 35 wherein said clinical trial service is selected from the group consisting of: scientific consulting, site support, study management, image and data management, image reading, site selection, and regulatory submission.

37. The system of claim 36 wherein said clinical trial service is image reading and said activity is selected from the group consisting of: equipment performance assessment, patient eligibility assessment, image quality control, image analysis, multi-reader adjudication, patient safety assessment, third party image quality control, third party image analysis, and intra- and inter-reader validation.

38. The system of claim 33 wherein said database further comprises at least one task associated with each of said at least one activity and wherein said at least one tool is associated with each of said at least one task.

39. The system of claim 38 wherein said medical service is a clinical trial service,
wherein said clinical trial service is image reading,
wherein said at least one activity is image analysis,
wherein said at least one task is selected from the group consisting of: image viewing specifications completion and confirmation, analysis baseline confirmation, blinding requirement confirmation, method of outlier checking determination, reader training and qualification, analysis, and report generation.

40. The system of claim 39 wherein said at least one tool is selected from the group consisting of: a site database and an image viewing system.

41. A method for providing a medical service requested by a client comprising the steps of:
defining a plurality of offerings associated with said medical service;
defining at least one service category associated with each of said offerings;
defining at least one activity associated with each of said at least one service category;
defining at least one tool associated with each of said at least one activity;
associating each of said plurality of offerings, said at least one activity, said at least one service category and said at least one tool;
defining, in response to said medical service requested by said client, at least one offering, service category, activity and tool required to provide said medical service to said client; and
providing said medical service to said client.

42. The method of claim 41 wherein said medial service is a clinical service.

43. The method of claim 42 wherein said clinical service is a clinical trial service.

44. The method of claim 43 wherein said clinical trial service is selected from the group consisting of: scientific consulting, site support, study management, image and data management, image reading, site selection, and regulatory submission.

45. The method of claim 44 wherein said clinical trial service is image reading and said activity is selected from the group consisting of: equipment performance assessment, patient eligibility assessment, image quality control, image analysis, multi-reader adjudication, patient safety assessment, third party image quality control, third party image analysis, and intra- and inter-reader validation.

46. The method of claim 41 further comprising the step of defining at least one task associated with each of said at least one activity and wherein the step of defining said at least one tool defines said at least one tool associated with each of said at least one task.

47. The method of claim 46 wherein said medical service is a clinical trial service,
wherein said clinical trial service is image reading,
wherein said at least one activity is image analysis,
wherein said at least one task is selected from the group consisting of: image viewing specifications completion and confirmation, analysis baseline confirmation, blinding requirement confirmation, method of outlier checking determination, reader training and qualification, analysis, and report generation.

48. The method of claim 47 wherein said at least one tool is selected from the group consisting of: a site database and an image viewing system.
